(19) United States
(12) Patent Application Publication
(10) Pub. No.: US 2025/0029052 A1
(43) Pub. Date: Jan. 23, 2025

(54) TRANSPORT PLAN GENERATING DEVICE, TRANSPORT PLAN GENERATING METHOD, AND TRANSPORT PLAN GENERATING PROGRAM

(71) Applicant: HONDA MOTOR CO., LTD., Tokyo (JP)

(72) Inventors: Soji KASHIMA, Saitama (JP); Michiyo INOUE, Tokyo (JP); Kentaro SUGIMURA, Saitama (JP); Yuji MATSUO, Tokyo (JP)

(73) Assignee: HONDA MOTOR CO., LTD., Tokyo (JP)

(21) Appl. No.: 18/713,715

(22) PCT Filed: Nov. 29, 2021
(86) PCT No.: PCT/JP2021/043628

§ 371 Date: May 28, 2024

(51) Int. Cl. G06Q 10/0832; G06Q 10/0631; G06Q 50/06

(52) U.S. Cl. CPC G06Q 10/0832; G06Q 10/06315; G06Q 50/06

(57) ABSTRACT

A transport plan generating device 10, upon acquiring work plan information including information indicating the location of a worksite Cs where a work machine M is to be used, references a storage unit storing information indicating the location of each local base, identifies a nearby local base (local base Lb1), that is, a local base in the vicinity of the worksite Cs, generates a battery BAT transport plan with the nearby local base set as the transport destination, and presents the transport plan to an employee at a hub base Hb that serves as the transport origin.

### TECHNICAL FIELD

The present invention relates to a transport plan generating device that generates a transport plan for a battery, a transport plan generating method, and a transport plan generating program.

### BACKGROUND ART

In recent years, efforts to realize a low-carbon or decarbonized society have become more active as concrete measures against global climate change. As part of this effort, electrification of various devices is progressing. For example, as for a vehicle, development of an electric vehicle using an electric motor as a drive source is progressing. This wave of electrification is also spreading to work machines used for predetermined works, such as lawn mowers and blowers.

Further, in recent years, battery sharing services have been provided that rent out batteries to users. By using the battery sharing service, a user can rent a charged battery at a predetermined rental location (for example, a rental company's counter or a storage device called a “battery stand”).

Patent Literature 1 discloses a technology that, when receiving an information request from a user's terminal regarding a dealer or rental company that holds power supply equipment that can be rented, sends information such as a location of the dealer or rental company to the terminal.

### CITATION LIST

### Patent Literature

Patent Literature 1: JP2019-164644A

### SUMMARY OF INVENTION

### Technical Problem

However, in the technology of the related art, there is room for improvement from a viewpoint of providing a battery sharing service that efficiently utilizes a limited number of batteries.

The present invention provides a transport plan generating device, a transport plan generating method, and a transport plan generating program that make it possible to provide a battery sharing service that efficiently utilizes a limited number of batteries.

### Solution to Problem

A first invention is,
a transport plan generating device for generating a transport plan of a battery that is to be attached to an electric apparatus from a hub base station where the battery is stored to a local base station where the battery is lent out to a user, the transport plan generating device being configured to:
acquire use plan information including information representing a planned location of use for the electric apparatus, and specify a nearby local base station, which is a local base station located near the planned location of use, based on the use plan information by referring to a storage unit that stores information representing a location of each local base station,
generate the transport plan with the specified nearby local base station as a transport destination, and
output transport plan information representing the generated transport plan to a terminal device of the hub base station.

A second invention is,
a transport plan generating method executed by a computer for generating a transport plan of a battery that is to be attached to an electric apparatus from a hub base station where the battery is stored to a local base station where the battery is lent out to a user, the transport plan generating method being executed by the computer including:
acquiring use plan information including information representing a planned location of use for the electric apparatus, and specifying a nearby local base station, which is a local base station located near the planned location of use, based on the use plan information by referring to a storage unit that stores information representing a location of each local base station,
generating the transport plan with the specified nearby local base station as a transport destination, and
outputting transport plan information representing the generated transport plan to a terminal device of the hub base station.

A third invention is,
a transport plan generating program that causes a computer to execute a transport plan generating method for generating a transport plan of a battery that is to be attached to an electric apparatus from a hub base station where the battery is stored to a local base station where the battery is lent out to a user, the transport plan generating program causing the computer to execute processes of:
acquiring use plan information including information representing a planned location of use for the electric apparatus, and specifying a nearby local base station, which is a local base station located near the planned location of use, based on the use plan information by referring to a storage unit that stores information representing a location of each local base station,
generating the transport plan with the specified nearby local base station as a transport destination, and
outputting transport plan information representing the generated transport plan to a terminal device of the hub base station.

### Advantageous Effects of Invention

According to the present invention, it is possible to provide a battery sharing service that efficiently utilizes a limited number of batteries.

### BRIEF DESCRIPTION OF DRAWINGS

FIG. 1 is a diagram illustrating an example of a battery sharing service in a present embodiment.

FIG. 2 is a diagram illustrating an example of a battery transport support system 1 to which a transport plan generating device 10 is applied.

FIG. 3 is a diagram illustrating an example of a work plan information DB 31.

FIG. 4 is a diagram illustrating an example of a base station DB 11.

FIG. 5 is a diagram illustrating an example of a battery inventory management DB 12.

FIG. 6 is a flowchart illustrating an example of a transport plan generating method executed by the transport plan generating device 10.

FIG. 7 is a diagram illustrating an example of a transport plan generated when the number of transport batteries is large and a transport plan generated when the number of transport batteries is small.

FIG. 8 is a diagram illustrating an example of a transport plan summary presentation screen 800 displayed on a terminal device 20 that has received transport plan information.

FIG. 9 is a diagram illustrating an example of a detailed transport plan confirmation screen 900 that is displayed when a detailed transport plan confirmation button 802 on the transport plan summary presentation screen 800 is clicked.

FIG. 10 is a diagram illustrating an example of a work plan information confirmation screen 1000 that is displayed when a work plan information confirmation button 803 on the transport plan summary presentation screen 800 is clicked.

### DESCRIPTION OF EMBODIMENTS

Hereinafter, an embodiment of a transport plan generating device, a transport plan generating method, and a transport plan generating program of the present invention will be described in detail with reference to drawings. In the following embodiments, an example will be described in which electric apparatus according to the present invention is a work machine used for a predetermined work, such as a lawn mower or a blower.

### [Battery Sharing Service]

First, a battery sharing service in the present embodiment will be described. The battery sharing service (hereinafter, also simply referred to as “battery sharing service”) of the present embodiment is a service in which a rental company lends a battery (hereinafter also referred to as “battery BAT”) that can be attached to an electric work machine to a user via an intermediary company.

Here, the battery BAT is mainly composed of a secondary battery such as a lithium ion battery, and when attached to an electric work machine, functions as a power source for driving a drive source of the work machine. Further, the user of the battery sharing service can be, for example, a worker who performs work using a work machine. Specifically, the user of the battery sharing service can be an employee of a landscaping company that undertakes maintenance of a predetermined public space such as a park. In the following, the user of the battery sharing service will be described as a worker.

The three parties, the rental company, the intermediary company, and the worker (landscaper), have concluded a contract regarding the battery sharing service in advance, and when a battery BAT is lent to the worker, the worker pays a rental fee to the rental company, and the rental company pays a commission to the intermediary company. Therefore, when the battery BAT can be rented out, not only the rental company but also the intermediary company can get compensation.

The rental company is, for example, a manufacturer of the battery BAT. The manufacturer of the battery BAT can improve worker convenience through the battery sharing service, as described below, so it can encourage transition from a non-electrified work machine to an electrified work machine and contribute to realization of a low-carbon or decarbonized society.

Further, the intermediary company is, for example, a logistics company that has base stations as logistics bases throughout the country. Here, the base stations include hub base stations that have a hub function in a logistics network of the intermediary company, and local base stations that are non-hub base stations. To be more specific, in an intermediary company's logistics network, packages delivered to a certain area are once collected at a hub base station that has jurisdiction over the area, and then sent to local base stations corresponding to each delivery destination. In other words, a logistics network for transporting such packages is established in advance between the hub base station and the local base station. Although details will be described below, the intermediary company can also transport the battery BAT using such an existing logistics network, thereby reducing an increase in costs associated with transporting the battery BAT.

Further, in the present embodiment, the local base station is a lending place where the batteries BATs are lent to workers. That is, a worker can rent a charged battery BAT by going to any local base station and requesting the rental of a battery BAT. Further, in the present embodiment, the local base station also functions as a return location that accepts the return of the battery BAT from the worker.

By the way, in order to lend out the battery BAT, it is necessary that the local base station to which the worker goes has a battery BAT that can be lent out. In other words, when there is no battery BAT available for rent at the local base station to which the worker goes, the local base station cannot lend the battery BAT to the worker even when the worker has intention of borrowing the battery BAT.

In order to avoid such a situation in which a battery BAT cannot be lent out, it is conceivable to pre-deploy a large number of batteries BATs in all local base stations, for example. However, in this case, in order to provide a battery sharing service, a large number of batteries BATs are required, and at local base stations where demand for batteries BATs is low, batteries BATs are left over. As a result, there is room for improvement from a viewpoint of effective utilization of batteries BATs.

Therefore, in the present embodiment, the batteries BATs are stored in the hub base station, and when demand for the battery BAT is expected in a local base station, the battery BAT is transported from the hub base station to the local base station. This makes it possible to provide a battery sharing service that efficiently utilizes the limited number of batteries BATs.

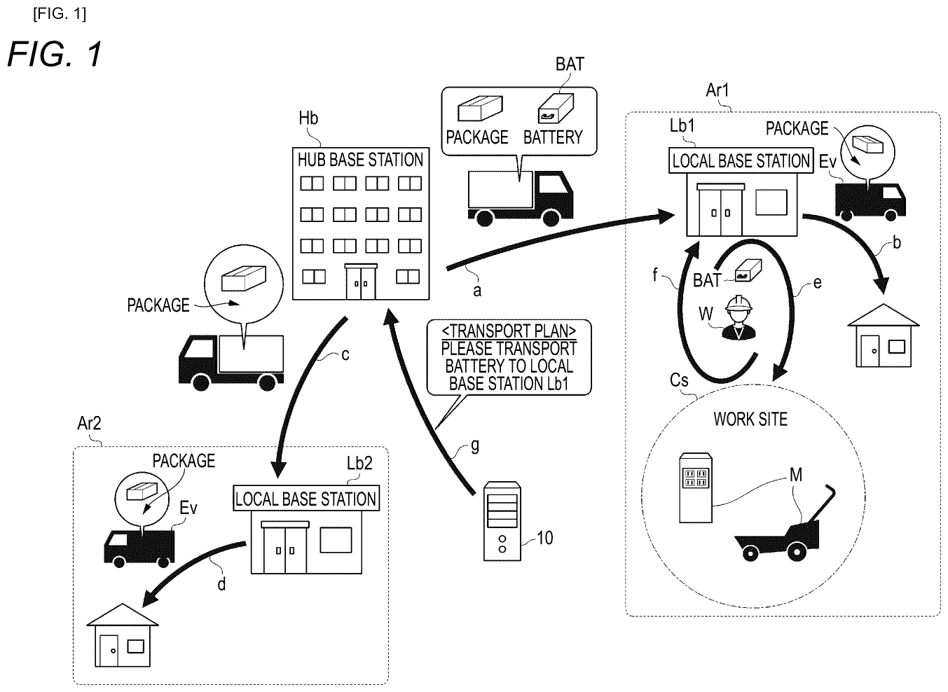

Hereinafter, with reference to FIG. 1, an example of the battery sharing service in the present embodiment will be specifically described.

In FIG. 1, a hub base station Hb is a hub base station of an intermediary company, and stores a battery BAT that is not lent out. By storing the battery BAT that is not lent out at a hub base station such as the hub base station Hb, it is possible to quickly transport the battery BAT to a local base station where demand for the battery BAT is expected. Further, since a hub base station is generally wider than a local base station, it is easier to secure a space for storing the battery BAT than a local base station.

A local base station Lb1 is a local base station of the intermediary company, is provided in a first area Ar1, and is responsible for delivering packages in the first area Ar1. To be more specific, packages to be delivered to the first area Ar1 are first collected at the hub base station Hb. Then, the packages to be delivered to the first area Ar1 are sent from the hub base station Hb to the local base station Lb1 (see the arrow a in FIG. 1), and are delivered from the local base station Lb1 to each delivery destination (see the arrow b in FIG. 1).

For example, an electric vehicle Ev that can travel using the battery BAT as a power source is used for delivery from the local base station Lb1. Therefore, the local base station Lb1 is provided with charging equipment (for example, a charger. Hereinafter also simply referred to as “charging equipment”) that can charge the battery BAT. The electric vehicle Ev may be a two-wheeled vehicle, a tricycle, a four-wheeled vehicle, or the like.

The local base station Lb1 also functions as a lending location where batteries BATs are lent to workers, and a return location where batteries BATs are returned from workers. As described above, since the local base station Lb1 is provided with charging equipment, by charging the battery BAT with this charging equipment, it is possible to rent out the charged battery BAT.

A local base station Lb2, like the local base station Lb1, is a local base station of the intermediary company, is provided in a second area Ar2, and is responsible for delivering packages in the second area Ar2. Specifically, packages to be delivered to the second area Ar2 are first collected at the hub base station Hb. Then, the packages to be delivered to the second area Ar2 are sent (see the arrow c in FIG. 1) from the hub base station Hb to the local base station Lb2, and are delivered (see the arrow d in FIG. 1) from the local base station Lb2 to each delivery destination.

For example, an electric vehicle Ev is used for delivery from the local base station Lb2. Therefore, local base station Lb2 is provided with charging equipment. The local base station Lb2 also functions as a lending location where batteries BATs are lent to workers, and a return location where batteries BATs are returned from workers. As described above, since the local base station Lb2 is provided with charging equipment, by charging the battery BAT with this charging equipment, it is possible to rent out the charged battery BAT.

A work site Cs is a place where work is performed by a worker W, which will be described below, and is, for example, a predetermined public space provided in the first area Ar1. At the work site Cs, a worker W, who is an employee of a landscaping company contracted to perform landscaping maintenance (for example, lawn mowing), uses a work machine M to perform work. The work machine M is an electric work machine that is driven using a battery BAT as a power source, and is, for example, a lawn mower or a blower. Further, the work machine M may be a portable discharge machine or the like that can generate AC power from an attached battery BAT and supply the generated AC power to other electronic devices.

By the way, demand for landscaping work is generally limited to a limited period. For example, the demand for landscaping work is low in a winter season with heavy snowfall and snow, but the demand for landscaping work tends to increase during the summer when plants are actively growing. Further, a site area of the work site undertaken by the landscaping company varies depending on the work site, and may be small or vast. Due to these factors, the number of batteries BATs required by a landscaping company may vary from day to day, but it is undesirable from a cost and management standpoint for a landscaping company to keep a large number of batteries BATs on hand at all times so as not to run out of batteries BATs under any circumstances. Further, for example, it requires a lot of effort and labor for the worker W to bring a large number of batteries BATs from a landscaping company's warehouse to the work site Cs and charge them after work. On the other hand, when the worker W can borrow a battery BAT that has been charged at the local base station Lb1 near the work site Cs, it is possible to reduce such labor.

Therefore, the worker W uses the battery sharing service. Specifically, before going to the work site Cs, the worker W goes to the local base station Lb1 to borrow a battery BAT to be used for that day's work (see the arrow e in FIG. 1). When the worker W finishes his or her work for the day, he or she returns the used battery BAT to the local base station Lb1 (see the arrow f in FIG. 1). An employee of the local base station Lb1 charges the returned battery BAT using the charging equipment of the local base station Lb1 in preparation for lending it the next day. As a result, the next day, the worker W can also borrow a charged battery BAT to be used for that day's work at the local base station Lb1.

By the way, in order to enable the worker W to use the battery sharing service, it is assumed that an amount of batteries BATs that the worker W wants to borrow is available at the local base station Lb1 when the worker W goes to the local base station Lb1.

Therefore, when work plan information including information representing the work site Cs is acquired, a transport plan generating device 10, which is an example of a transport plan generating device of the present invention generates a transport plan for batteries BATs with the local base station Lb1 located near the work site Cs as a transport destination, and transmits the transport plan information representing the transport plan to a terminal device of the hub base station Hb, thereby presenting the transport plan to the employee of the hub base station Hb (see the arrow g in FIG. 1).

Here, the transport plan includes at least information on the transport destination (here, the local base station Lb1). Thereby, the employee of the hub base station Hb can be prompted to transport the batteries BATs to the local base station that has become the transport destination. For example, when a transport plan is presented with the local base station Lb1 as the transport destination, as illustrated in FIG. 1, the employee of the hub base station Hb also transports the battery BAT when transporting a package from the hub base station Hb to the local base station Lb1. Thereby, the battery BAT can be efficiently transported to the local base station Lb1.

As described above, according to the transport plan generating device 10, it becomes possible to deploy batteries BATs at a local base station where demand for the batteries BATs is expected, and it becomes possible to provide the battery sharing service that efficiently utilizes the limited number of batteries BATs.

In the example described above, the battery BAT is returned to the local base station (for example, the local base station Lb1), but the present invention is not limited to this. For example, the battery BAT may be returned to a return box provided in the city. In this case, an employee of the local base station can, for example, check the return box when picking up a package and, when there is a battery BAT, take it back to the local base station. Further, the return box may be used only for returning the battery BAT, or may be used to drop other items as well.

When the battery BAT is returned to the return box, it may take some time to return to the local base station. Therefore, in such a case, the transport plan generating device 10 may generate a transport plan that transports a certain number of batteries BATs with a certain margin to the local base station of the transport destination.

Further, the transport plan generating device 10 may output, for example, to a terminal device (for example, a smartphone) of the worker who borrowed the battery BAT, location information of return boxes around the worker. In this way, it is possible to inform the worker who borrowed the battery BAT of the location of the return box, thereby improving the convenience of the worker. The return box may be provided at a work site where the worker who borrowed the battery BAT performs work.

Further, the worker who borrowed the battery BAT may request the transport plan generating device 10 to collect the battery BAT using a terminal device or the like. This collection request includes, for example, information on a battery BAT collection location specified by the worker. The transport plan generating device 10 that has received the collection request may output information to a terminal device of a local base station near the collection location that a battery BAT collection request has been made. In this case, the employee of the local base station only has to go and collect the battery BAT in response to the collection request. Further, when the worker receives a message indicating that the battery cannot be collected in response to the collection request, the worker may return the battery BAT himself or herself to a predetermined return location (local base station or return box).

Hereinafter, an example of a battery transport support system to which the transport plan generating device 10 of the present embodiment is applied will be specifically described.

### [Battery Transport Support System]

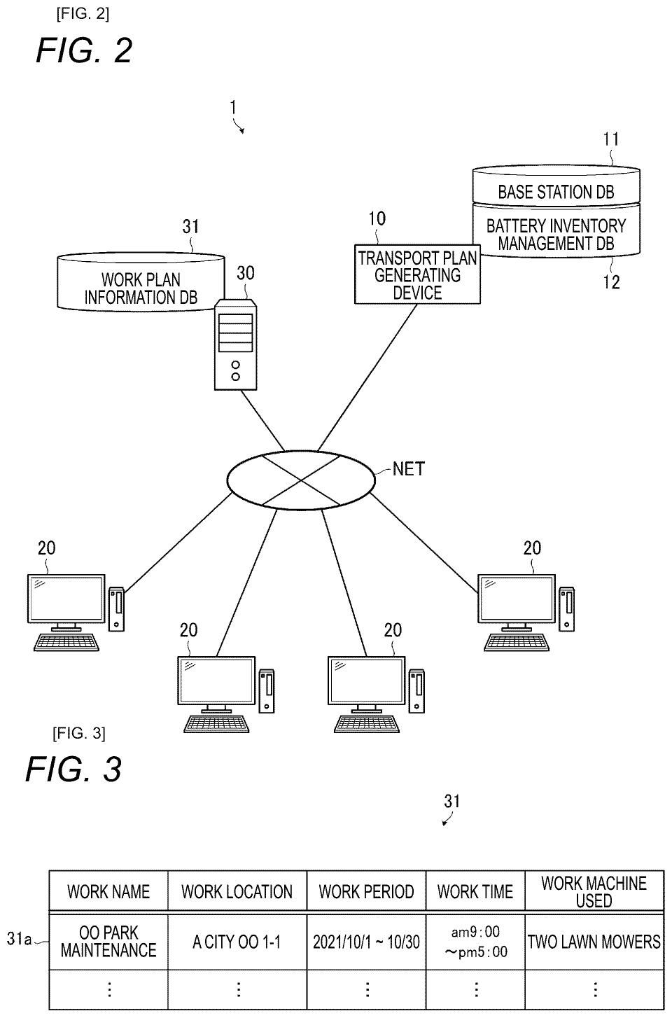

As illustrated in FIG. 2, a battery transport support system 1 of the present embodiment is configured by providing the transport plan generating device 10 capable of communicating with each of a plurality of terminal devices 20 and a work plan information providing server 30 via a network NET. The network NET is, for example, the Internet.

The transport plan generating device 10 is a server (computer) managed by the rental company that provides the battery sharing service illustrated in FIG. 1 and the like. The transport plan generating device 10 may be a virtual server (cloud server) implemented in a cloud computing service, or may be a physical server implemented as a single device.

The transport plan generating device 10 has a storage unit (not illustrated) that stores a base station database (DB) 11 and a battery inventory management DB 12. This storage unit is realized, for example, by a nonvolatile (non-transitory) storage medium such as a hard disk or flash memory. A specific example of the base station DB 11 and battery inventory management DB 12 will be described below. The base station DB 11 and the battery inventory management DB 12 may be provided in an external storage unit that can be referenced by the transport plan generating device 10.

The plurality of terminal devices 20 include a terminal device (computer) provided at the base station of the aforementioned intermediary company, and a terminal device provided at a government office of a local government that manages a predetermined public space. A terminal device 20, which is a terminal device provided in a base station, is used by a base station employee who works at the base station. A terminal device 20, which is a terminal device provided in a government office, is used by a local government employee working there. Further, the plurality of terminal devices 20 may further include any terminal device (for example, a terminal device used by the general public other than a base station employee and a local government employee) connected to the network NET.

The terminal device 20 is, for example, a personal computer, a smartphone, a tablet terminal, or the like, and includes an input device such as a keyboard or a touch panel that receives operation input from a user, and an output device such as a display or a speaker that outputs various information to the user.

The work plan information providing server 30 is a server that can be accessed by the transport plan generating device 10 and the terminal device 20, and is managed by, for example, a local government. The work plan information providing server 30 may be a virtual server (cloud server) implemented in a cloud computing service, or may be a physical server implemented as a single device. The work plan information providing server 30 may be provided integrally with the transport plan generating device 10. Further, the work plan information providing server 30 may be provided individually corresponding to each local government.

The work plan information providing server 30 has a work plan information DB 31 that stores work plan information regarding work such as maintenance of public spaces.

### [Work Plan Information DB]

Here, a specific example of the work plan information DB 31 will be described. As illustrated in FIG. 3, the work plan information DB 31 stores work plan information in which a work name as an identifier for identifying each work is associated with information representing a work location, a work period, a work time, and a work machine used. Work plan information is an example of use plan information in the present invention.

In the work plan information, the information representing the work location represents the address and latitude and longitude that specify the location where the work will be performed. The information representing the work period represents, for example, the work start date and the work end date, and represents the work period, which is the period during which the work is performed. The information representing the work time represents the time period in which the work is performed on the work day during the work period. The information representing the work machines used represents the type and number of work machines used for the work.

To be more specific, work plan information 31a illustrated in FIG. 3 represents that work “OO park maintenance” will be carried out at a location “A city OO 1-1” during the period from “Oct. 1, 2021 to Oct. 30, 2021”. Further, the work plan information 31a represents that for the work “OO park maintenance”, the work will be carried out from 9:00 a.m. to 5:00 p.m. (that is, 8 hours of work per day), and that “two lawn mowers” will be used as work machines.

For example, when it is decided to carry out work such as maintenance of the public space, a local government employee who manages the public spaces uses the terminal device 20 to register work plan information corresponding to the work in the work plan information DB 31 of the work plan information providing server 30 for the purpose of notifying neighboring residents living around the public space. Part (for example, the work machine used) or all of the work plan information may be registered by an employee of a landscaping company contracted by the local government to perform the work.

A user of any terminal device 20 can appropriately check the work plan information stored in the work plan information DB 31 by accessing the work plan information providing server 30 through the terminal device 20. Similarly, the transport plan generating device 10 can appropriately refer to the work plan information stored in the work plan information DB 31 by accessing the work plan information providing server 30, so based on the work plan information, it is possible to predict where, when, and how much the battery BAT is likely to be used.

### [Base Station DB]

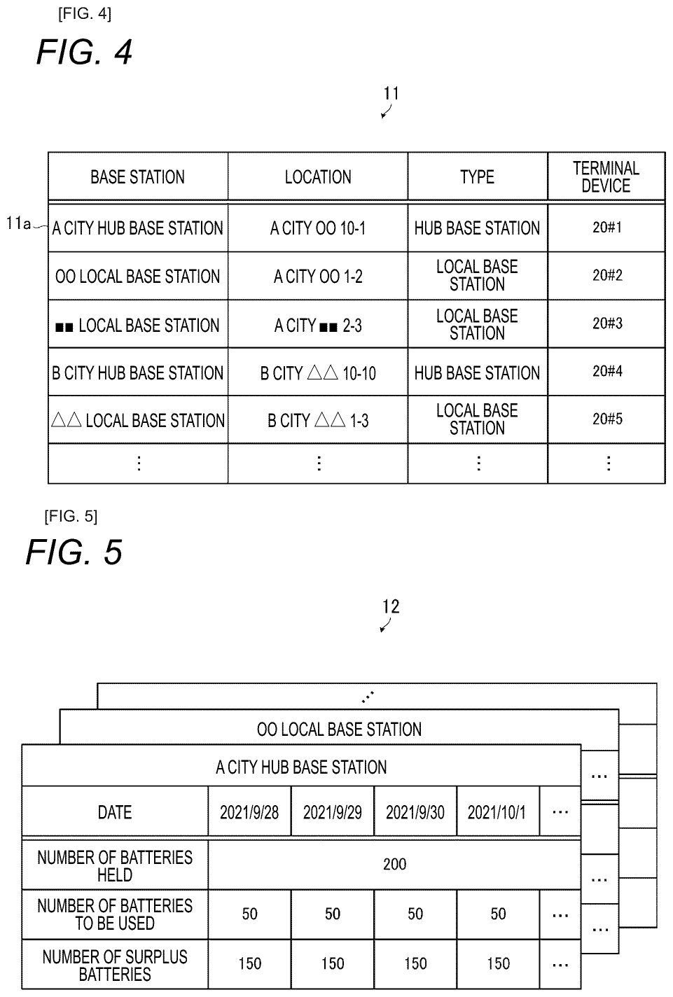

Next, an example of the base station DB 11 mentioned above will be described. As illustrated in FIG. 4, the base station DB 11 stores base station information in which a base station name as an identifier to identify each base station is associated with information representing the location of the base station, the type of the base station, and the terminal device 20 provided at the base station.

In the base station information, the information representing the location of the base station represents the address and latitude and longitude that specify the location of the base station. The information representing the type of base station represents whether the base station is a hub base station or a local base station. The information representing the terminal device 20 provided in the base station represents an identifier for identifying the terminal device 20.

To be more specific, a base station information 11a illustrated in FIG. 4 indicates that a hub base station “A city hub base station” is located at a location “A city OO 10-1”. Further, the base station information 11a represents that a terminal device 20 called “20 #1” is provided in a hub base station called “A city hub base station”.

By referring to such a base station DB 11, the transport plan generating device 10 can specify the location and type of each base station, as well as the terminal device 20 provided at each base station.

### [Battery Inventory Management DB]

Next, an example of the battery inventory management DB 12 mentioned above will be described. As illustrated in FIG. 5, the battery inventory management DB 12 stores information representing the number of batteries held, the number of batteries to be used, and the number of surplus batteries for each base station.

Here, the number of batteries held is the total number of batteries BATs held by the base station. The number of batteries to be used is the number of batteries BATs that are expected to be used among the batteries BATs held by the base station. The number of surplus batteries is obtained by subtracting the number of batteries to be used from the number of batteries held.

Further, in the present embodiment, the number of batteries to be used may vary from day to day because the batteries BAT are lent to workers. Therefore, as illustrated in FIG. 5, the battery inventory management DB 12 stores information representing the number of batteries held, the number of batteries to be used, and the number of surplus batteries for each base station and each day.

To be more specific, the battery inventory management DB 12 in the example illustrated in FIG. 5 stores information representing that the number of batteries held by “A city hub base station” is “200”. In addition, the battery inventory management DB 12 in this example stores information representing that the number of batteries to be used in “A city hub base station” on “Sep. 28, 2021” is “50” and the number of surplus batteries is “150”. Similarly, the battery inventory management DB 12 of this example stores information representing that the number of batteries to be used in “A city hub base station” on “Sep. 29, 2021” and “Sep. 30, 2021” is also “50”, and representing that the number of surplus batteries is “150”.

By referring to the battery inventory management DB 12, the transport plan generating device 10 can grasp the number of daily surplus batteries (that is, the number of batteries BATs that can be lent to users) of each base station.

### [Transport Plan Generating Method]

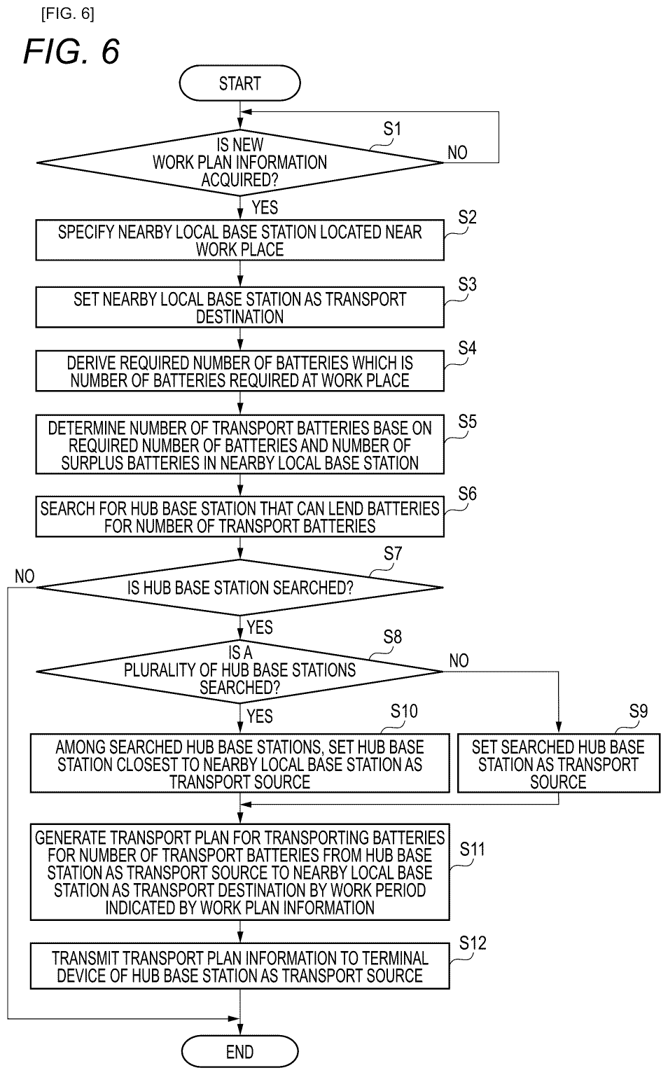

Next, with reference to FIG. 6, an example of a transport plan generating method executed by the transport plan generating device 10 will be described. A transport plan generating program that causes the transport plan generating device 10 to execute this transport plan generating method is stored in advance in the storage unit (storage medium) of the transport plan generating device 10 described above, for example. Then, by executing this transportation plan generation program, for example, by a processor of the transport plan generating device 10, the transport plan generating method illustrated in FIG. 6 is performed.

As illustrated in FIG. 6, the transport plan generating device 10 first determines whether new work plan information has been acquired (step S1). For example, the transport plan generating device 10 periodically checks whether new work plan information has been registered in the work plan information DB 31, and when new work plan information has been registered, acquires the work plan information. When new work plan information has been acquired in this way, the transport plan generating device 10 proceeds to the process of step S2 (step S1: YES). On the other hand, when work plan information has not been acquired, the transport plan generating device 10 repeats the process of step S1 until new work plan information is acquired (step S1: NO loop).

Next, the transport plan generating device 10 refers to the base station DB 11 and specifies a nearby local base station, which is a local base station located near the work place, based on the acquired work plan information (step S2), and then the transport plan generating device 10 sets the specified nearby local base station as a transport destination of the battery BAT (step S3).

In step S2, the transport plan generating device 10 specifies, for example, the local base station closest to the work place represented by the acquired work plan information as a nearby local base station. Here, the local base station closest to the work place is, for example, the local base station with the shortest straight line distance to the work place. Further, the local base station closest to the work place may be a local base station that has the shortest route to the work place.

Next, in order to determine the number of transport batteries, which is the number of batteries BATs to be transported to the nearby local base station set as the transport destination, the transport plan generating device 10 first derives the required number of batteries, which is the number of batteries BATs required at the work place (step S4).

The required number of batteries can be derived based on the work time and work machines used that are represented by the acquired work plan information. To be more specific, the transport plan generating device 10 has registered in advance information representing an amount of power consumed by each work machine per unit time. Further, the work time in the work plan information can be regarded as the driving time per day of each work machine in the work machines to be used. Therefore, the transport plan generating device 10 can determine the daily power consumption of each work machine in the work machines to be used from the work time in the work plan information and the power consumption per unit time of each work machine in the work machines to be used. Then, the transport plan generating device 10 derives the sum of the power consumption per day of each work machine determined in this way as the power consumption per day at the work place.

In step S4, the transport plan generating device 10 derives the required number of batteries by dividing the derived daily power consumption in the work place by the power amount (hereinafter also referred to as “storable power amount”) that can be stored per battery BAT. Further, the storable power amount used in this case may be a value that varies depending on the state of health (SOH) of the battery BAT. In this way, it becomes possible to derive the required number of batteries while also taking into account the deterioration of the battery BAT.

Further, the transport plan generating device 10 may perform machine learning on past work performance and derive the required number of batteries or the daily power consumption at the work place based on the learning results. In this way, it becomes possible to derive the required number of batteries with high accuracy.

Next, the transport plan generating device 10 determines the number of transport batteries to be transported to the nearby local base station set as the transport destination based on the derived required number of batteries and the number of surplus batteries in the nearby local base station (step S5). For example, the transport plan generating device 10 uses the number obtained by subtracting the number of surplus batteries of the nearby local base station from the number of required batteries as the number of transport batteries. Further, the number of surplus batteries used in this case can be, for example, the minimum value of the number of surplus batteries of the nearby local base station during the work period represented by the acquired work plan information. As a result, even when the number of surplus batteries at the nearby local base station varies, it is possible to avoid a situation where the required number of batteries BATs cannot be lent to workers due to a shortage of batteries BATs at the nearby local base station during the work period.

Next, the transport plan generating device 10 refers to the battery inventory management DB 12 and searches for a hub base station that can lend batteries BATs for the derived number of transport batteries (step S6). In step S6, the transport plan generating device 10 searches for a hub base station where the number of surplus batteries during the work period represented by the acquired work plan information is greater than the number of transport batteries, as a hub base station that can lend batteries BATs for the number of transport batteries.

Then, the transport plan generating device 10 determines whether a hub base station that can lend batteries BATs for the number of transport batteries has been searched (step S7). When a hub base station that can lend batteries BATs for the number of transport batteries is not searched (step S7: NO), the transport plan generating device 10 directly ends the series of processes illustrated in FIG. 6.

On the other hand, when a hub base station that can lend batteries BATs for the number of transport batteries is searched (step S7: YES), the transport plan generating device 10 determines whether there is a plurality of searched hub base stations (step S8). When one hub base station is searched (step S8: NO), the transport plan generating device 10 sets the searched hub base station as a transport source (step S9).

On the other hand, when there are a plurality of searched hub base stations (step S8: YES), among the searched hub base stations, the transport plan generating device 10 sets the hub base station closest to the nearby local base station of the transport destination as the transport source (step S10). Here, the hub base station closest to the nearby local base station is, for example, the hub base station with the shortest straight line distance to the nearby local base station. Further, the hub base station closest to the nearby local base station may be the hub base station with the shortest route to the nearby local base station.

Next, the transport plan generating device 10 generates a transport plan for transporting batteries BATs for the number of transport batteries derived in step S5 from the hub base station as the transport source set in step S9 or step S10 to the nearby local base station as the transport destination set in step S3 (step S11). In this case, the transport plan generating device 10 generates a transport plan such that the transport of the batteries BATs is completed by the work period (work start date) represented by the acquired work plan information. A specific example of the transport plan will be described below.

After generating the transport plan, the transport plan generating device 10 transmits transport plan information representing the generated transport plan to the terminal device 20 of the hub base station as a transport source (Step S12), and ends the series of processes illustrated in FIG. 6.

In the above example, when a hub base station that can lend batteries BATs for the number of transport batteries is not searched, the transport plan generating device 10 immediately ends the series of processes illustrated in FIG. 6, but the present invention is not limited to this.

For example, when a hub base station that can lend batteries BATs for the number of transport batteries is not searched, the transport plan generating device 10 may search for a plurality of hub base stations of which the total number of surplus batteries is equal to or greater than the number of transport batteries. In this case, the plurality of hub base stations may be selected in the order of having the most surplus batteries, or in the order of the distance to the nearby local base station that is the transport destination. By searching for a plurality of hub base stations of which the total number of surplus batteries is equal to or greater than the number of transport batteries, when the surplus batteries of one hub base station cannot secure enough batteries BATs for the number of transport batteries, it is possible to secure enough batteries BATs for the number of transport batteries using the surplus batteries of the plurality of hub base stations. Also, when the transport plan generating device 19 searches for a plurality of hub base stations in this way, the transport plan generating device 10 determines the number of batteries BATs to be transported from each hub base station to the nearby local base station in a range of surplus batteries. Then, the transport plan generating device 10 generates a transport plan for transporting the determined number of batteries BATs from each hub base station to the nearby local base station.

### [Specific Example of Transport Plan]

Next, a specific example of a transport plan generated by the transport plan generating device 10 will be described. As described above, in the present embodiment, the battery BAT is transported using the logistics network of the intermediary company. Therefore, it may be difficult to transport a large number of batteries BATs at once. Therefore, when the number of transport batteries is large, the transport plan generating device 10 generates a transport plan for transporting the batteries BATs in multiple times.

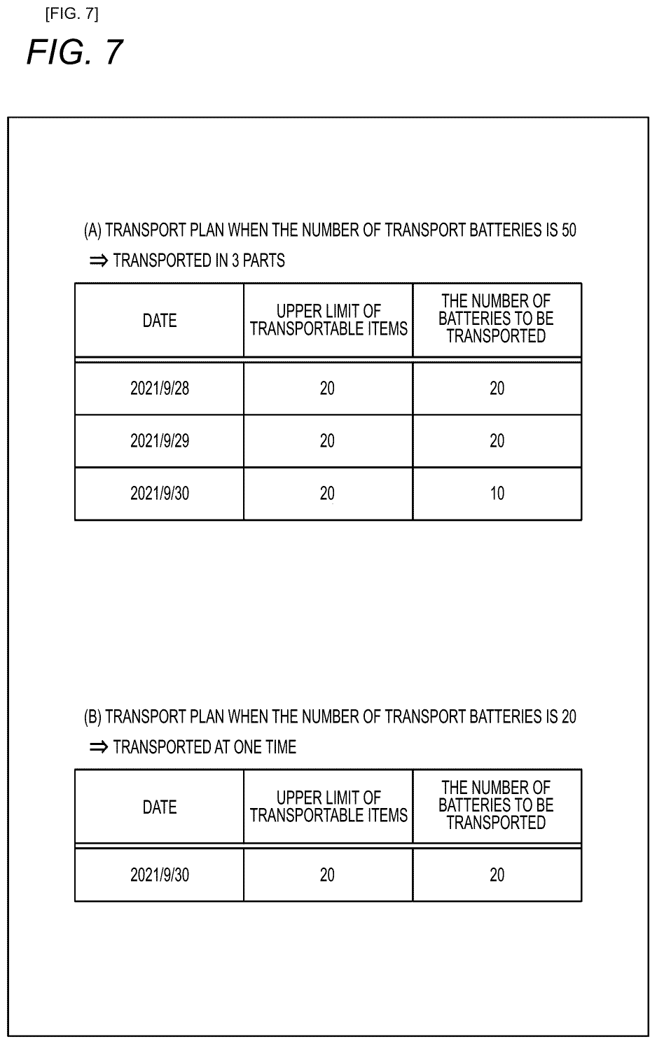

To be more specific, in the present embodiment, as illustrated in FIG. 7, an upper limit of the transportable items, which is an upper limit number of batteries BATs that can be transported per one transport, is set in advance. In an example illustrated in FIG. 7, the upper limit of the transportable items is set to 20. The upper limit of the transportable items is determined by taking into consideration, for example, the maximum loading capacity of a freight vehicle used to transport packages from the hub base station as the transport source to the local base station (that is, nearby local base station) as the transport destination, and the amount of packages transported from the hub base station as the transport source to the local base station as the transport destination. Further, since the amount of packages transported from the hub base station as the transport source to the local base station as the transport destination can vary from day to day, the upper limit of the transportable items may also be set to a value that differs from day to day.

Then, when the number of transport batteries is larger than the upper limit of the transportable items, the transport plan generating device 10 generates a transport plan for transporting the batteries BATs in multiple times. As a specific example, consider a case where 50 batteries BATs are to be transported to a local base station as a transport destination by Oct. 1, 2021. In this case, the transport plan generating device 10 determines the number of times of transport for transporting batteries BATs for the number of transport batteries to the nearby local base station based on the number of transport batteries (50 pieces) and the upper limit of the transportable items (20 pieces). For example, when the number of times of transport is n (where n is a natural number equal to or greater than 1), the transport plan generating device 10 determines the number of times of transport such that 20 (that is, the upper limit of the transportable items)×n≥50 (that is, the number of transport batteries). As a result, for example, as illustrated in FIG. 7 (A), when it is determined that 50 batteries BATs are to be transported in three parts (that is, the number of times of transport=3 times), the transport plan generating device 10 generates a transport plan to transport 20 batteries BATs on Sep. 28, 2021 and Sep. 29, 2021 each, and transport 10 batteries BATs on Sep. 30, 2021 from the hub base station as the transport source to the local base station as the transport destination.

On the other hand, consider a case where 20 batteries BATs are to be transported to a local base station as a transport destination by Oct. 1, 2021. In this case as well, similarly to the above example, the transport plan generating device 10 determines the number of times of transport such that 20 (that is, the upper limit of the transportable items) x n≥50 (that is, the number of transport batteries). As a result, for example, as illustrated in FIG. 7 (B), when it is determined that 20 batteries BATs are to be transported at one time (that is, the number of times of transport=1 time), the transport plan generating device 10 generates a transport plan to transport 20 batteries BATs on Sep. 30, 2021 from the hub base station as the transport source to the local base station as the transport destination.

As described above, the transport plan generating device 10 determines the number of times of transport to transport the batteries BATs for the number of transport batteries to the nearby local base station based on the number of transport batteries and the upper limit number (the upper limit of the transportable items) of batteries that can be transported per one transport. As a result, taking into account the logistics network between the hub base station as the transport source and the nearby local base station as the transport destination, it is possible to appropriately transport the batteries BATs for the number of transport batteries from the hub base station as the transport source to the nearby local base station.

Further, when the number of times of transport increases, it is assumed that the time required to complete the transport becomes longer. Therefore, the transport plan generating device 10 advances the timing of starting transport to the nearby local base station as the number of times of transport increases. Thereby, even when the number of times of transport increases, it is possible to avoid a delay in the timing at which the transport of batteries BATs for the number of transport batteries to be transported to the nearby local base station is completed.

In the example illustrated in (A) of FIG. 7, the transport plan generating device 10 generates a transport plan for transporting 50 batteries BATs in three parts, but the present invention is not limited to this. In other words, it is sufficient that the number of batteries BATs to be transported per one transport does not exceed the upper limit of the transportable items, and for example, the transport plan generating device 10 may generate a transport plan for transporting 50 time batteries BATs in 5 times of 10 each. Similarly, in the example illustrated in (B) of FIG. 7, the transport plan generating device 10 generates a transport plan for transporting 20 batteries BATs at one time, but for example, the transport plan generating device 10 may generate a transport plan for transporting 20 batteries BATs in 2 times of 10 each.

### [Example of Transport Plan Information]

Next, a display example by the terminal device 20 that has received transport plan information from the transport plan generating device 10 will be described.

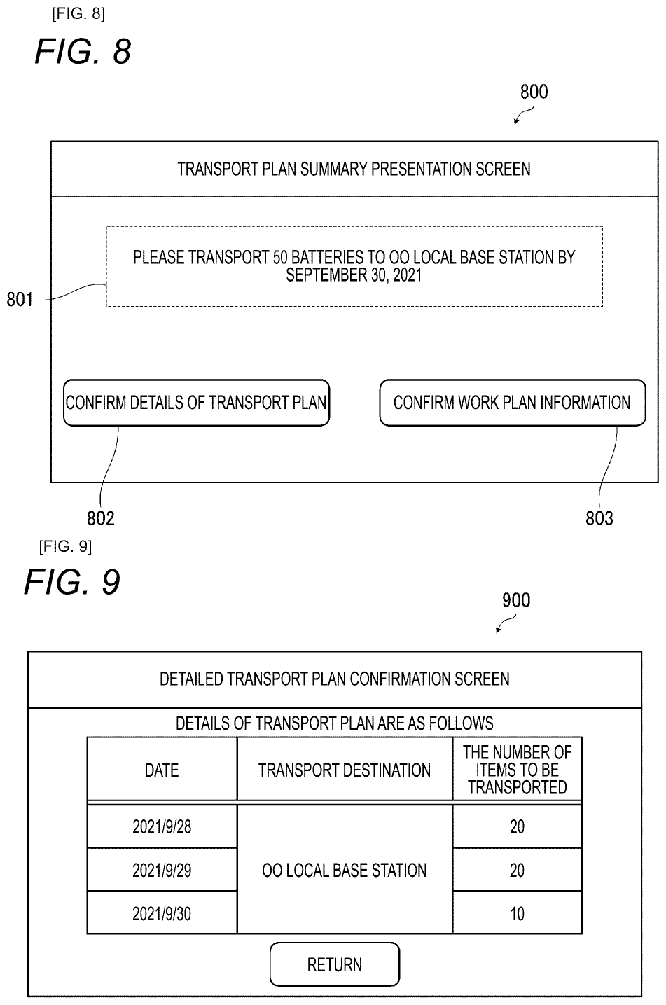

When the terminal device 20 of the hub base station as the transport source receives transport plan information from the transport plan generating device 10, it displays, for example, a transport plan summary presentation screen 800 illustrated in FIG. 8 on its own display based on the transport plan information.

On the transport plan summary presentation screen 800, a message 801 representing the summary of the transport plan, a detailed transport plan confirmation button 802, and a work plan information confirmation button 803 are displayed. The message 801 represents, for example, how many (that is, the number of transport batteries) batteries BATs should be transported to which local base station (that is, the transport destination) and by when. By checking the message 801, an employee of the hub base station as the transport source can easily know how many batteries BATs should be transported to which local base station and by when. Therefore, it is possible to urge the employee of the hub base station as the transport source to transport the batteries BATs according to the transport plan.

Further, when the detailed transport plan confirmation button 802 on the transport plan summary presentation screen 800 is clicked, the terminal device 20 displays a detailed transport plan confirmation screen 900 illustrated in FIG. 9 on its own display. The detailed transportation plan confirmation screen 900 displays the number of batteries BATs to be transported to the local base station as the transport destination on a daily basis. By checking the detailed transport plan confirmation screen 900, the employee of the hub base station as the transport source can know the details of the transport plan, such as how many batteries BATs should be transported on what day. Therefore, it is possible to urge the employee of the hub base station as the transport source to transport the batteries BATs according to the transport plan.

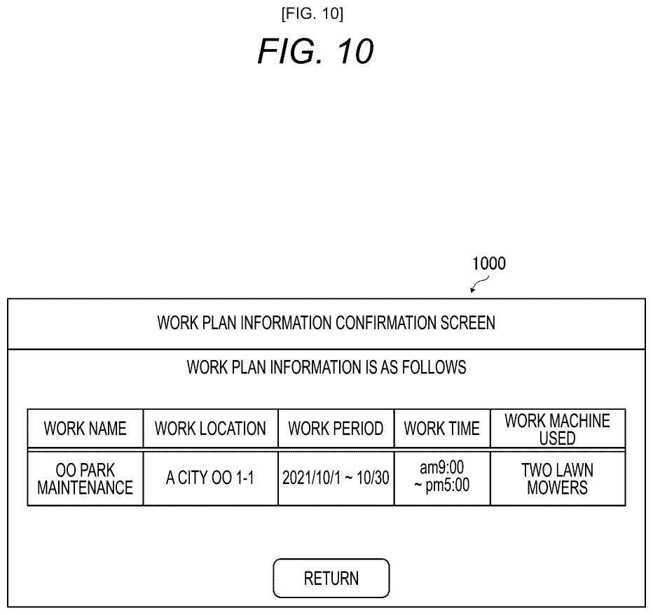

Further, when the work plan information confirmation button 803 on the transportation plan summary presentation screen 800 is clicked, the terminal device 20 displays a work plan information confirmation screen 1000 illustrated in FIG. 10 on its own display. The work plan information confirmation screen 1000 displays work plan information that triggered the generation of the transport plan. Therefore, the employee of the hub base station as the transport source can verify whether the transport plan is appropriate by checking the work plan information confirmation screen 1000.

As described above, when the transport plan generating device 10 acquires the work plan information, the transport plan generating device 10 refers to the base station DB 11 and specifies a nearby local base station located near the work place based on the work plan information, and then the transport plan generating device 10 generates a transport plan with the nearby local base station as the transport destination, and outputs transport plan information representing the transport plan to the terminal device 20 of the hub base station as the transport source. This makes it possible to urge the employee of the hub base station as the transport source to transport the batteries BATs to the nearby local base station located near the work place. This makes it possible to deploy batteries BATs at the local base station where demand for batteries BATs is expected, and to provide a battery sharing service that efficiently utilizes a limited number of batteries BATs.

In addition, the transport plan generating device 10 generates a transport plan in which the local base station closest to the work place is the transport destination and the nearby local base station is the transport destination. This allows the employee of the hub base station as the transport source to be urged to transport the batteries BATs to the nearby local base station closest to the work place, so it is possible to deploy batteries BATs at the local base station where demand for batteries BATs is expected.

Further, the transport plan generating device 10 generates a transport plan for transporting the batteries BATs to the nearby local base station by the work period (specifically, the work start date) based on the work plan information. Thereby, it is possible to urge the employee of the hub base station as the transport source to transport the batteries BATs to the nearby local base station by the work period. This makes it possible to deploy batteries BATs at the local base station where demand for batteries BATs is expected at times when demand for batteries BATs is expected.

In addition, the transport plan generating device 10 derives the required number of batteries required at the work place based on the work plan information, and the transport plan generating device 10 determines the number of transport batteries to be transported to the nearby local base station based on the required number of batteries, and then generates a transport plan for transporting batteries BATs for the number of transport batteries to the nearby local base station. Thereby, it is possible to urge the employee to transport an appropriate number of batteries BATs to the nearby local base station according to the required number of batteries required at the work place. This makes it possible to deploy an appropriate number of batteries BATs at the nearby local base station, making it possible to provide a battery sharing service that efficiently utilizes a limited number of batteries. Further, the transport plan generating device 10 determines the number of transport

batteries based on a difference between the required number of batteries and the number of surplus batteries held by the nearby local base station. This makes it possible to deploy an appropriate number of batteries BATs at the nearby local base station, making it possible to provide a battery sharing service that efficiently utilizes a limited number of batteries.

Further, the transport plan generating device 10 generates a transport plan with a hub base station having surplus batteries for the number of transport batteries as a transport source. This makes it possible to appropriately select the hub base station as the transport source according to the number of transport batteries.

Also, when there is a plurality of hub base stations with surplus batteries for the number of transport batteries, the transport plan generating device 10 generates a transport plan with the hub base station closest to the nearby local base station as the transport source among the plurality of hub base stations. This can reduce the effort and time required to transport the batteries BATs from the hub base station as the transport source to the nearby local base station as the transport destination.

Further, the transport plan generating device 10 determines the number of times of transport for transporting batteries BATs for the number of transport batteries to the nearby local base station based on the number of transport batteries and the upper limit number of batteries BATs that can be transported per one transport. As a result, taking into consideration the logistics network between the hub base station as the transport source and the nearby local base station as the transport destination, it is possible to appropriately transport batteries BATs for the number of transport batteries from the hub base station as the transport source to the nearby local base station as the transport destination.

In addition, the transport plan generating device 10 advances the timing of starting transport to the nearby local base station as the number of times of transport increases. Thereby, even when the number of times of transport increases, it is possible to avoid a delay in the timing at which the transport of batteries BATs for the number of transport batteries to be transported to the nearby local base station is completed.

The present invention is not limited to the embodiment described above, and can be modified, improved, and the like as appropriate.

For example, in the embodiment described above, an example is described in which the electric device is a work machine, but the electric device is not limited to a work machine. The electric device may be any device as long as it is driven by the power of a predetermined battery, such as the battery BAT in the embodiment described above, and may be, for example, an industrial machine or the like driven by the power of the battery BAT.

Further, in the embodiment described above, an example is described in which the intermediary company is a logistics company, but the intermediary company is not limited to a logistics company. The intermediary company may be, for example, a retailer that operates a convenience store, a gas station, or the like. Further, the above-described intermediary company may also serve as the above-described rental company by purchasing a battery BAT from a battery BAT manufacturer and renting out the purchased battery BAT.

This specification describes at least the following matters. Although components corresponding to those in the above-described embodiment are shown in parentheses, the present invention is not limited thereto.
(1) A transport plan generating device (transport plan generating device 10) for generating a transport plan of a battery (battery BAT) that is to be attached to an electric apparatus (work machine M) from a hub base station (hub base station Hb) where the battery is stored to a local base station (local base station Lb1) where the battery is lent out to a user (worker W), the transport plan generating device being configured to:
acquire use plan information including information representing a planned location of use for the electric apparatus, and specify a nearby local base station, which is a local base station located near the planned location of use, based on the use plan information,
generate the transport plan with the specified nearby local base station as a transport destination, and
output transport plan information representing the generated transport plan to a terminal device (terminal device 20) of the hub base station.
According to (1), an employee at the hub base station can be urged to transport the battery to the nearby local base station located near the planned location of use for the electric apparatus. This makes it possible to deploy the batteries at the local base station where demand for batteries is expected, and thus it is possible to efficiently utilize a limited number of batteries and provide a battery sharing service that lends batteries to users.
(2) The transport plan generating device according to (1), where
the nearby local base station is a local base station closest to the planned location of use.
According to (2), since it is possible to urge the employee to transport the battery to the nearby local base station closest to the planned location of use for the electric apparatus, it is possible to deploy the battery at the local base station where demand for the battery is expected.
(3) The transport plan generating device according to (1) or (2), where
the use plan information further includes information representing a planned time period of use of the electric apparatus, and
the transport plan generating device is configured to generate the transport plan for transporting the battery to the nearby local base station by the planned time period of use based on the use plan information.
According to (3), the employee at the hub base station can be urged to transport the battery to the nearby local base station by the planned time period of use of the electric apparatus. This makes it possible to deploy the battery at the local base station where demand is expected at times when demand for the battery is expected.
(4) The transport plan generating device according to any one of (1) to (3), where
the use plan information further includes information representing the electric apparatus, and
the transport plan generating device is configured to:
   derive a required number of batteries required at the planned location of use based on the use plan information,
   determine a number of transport batteries to be transported to the nearby local base station based on the required number of batteries, and
   generate the transport plan for transporting batteries for the number of transport batteries to the nearby local base station.
According to (4), it is possible to urge the employee to transport an appropriate number of batteries to the nearby local base station according to the required number of batteries required at the planned location of use. This makes it possible to deploy an appropriate number of batteries to the nearby local base stations, and thus it is possible to efficiently utilize a limited number of batteries and provide a battery sharing service that lends batteries to users.
(5) The transport plan generating device according to (4), where
the transport plan generating device is configured to determine the number of transport batteries based on a difference between the required number of batteries and a number of surplus batteries held in the nearby local base station.
According to (5), it is possible to deploy an appropriate number of batteries at the nearby local base station, and thus it is possible to efficiently utilize a limited number of batteries and provide a battery sharing service that lends batteries to users.
(6) The transport plan generating device according to (4) or (5), where
the transport plan generating device is configured to generate the transport plan with the hub base station having surplus batteries for the number of transport batteries as a transport source.
According to (6), it is possible to appropriately select the hub base station as the transport source according to the number of transport batteries.
(7) The transport plan generating device according to (6), where
when there is a plurality of hub base stations each having surplus batteries for the number of transport batteries, the transport plan generating device generates the transport plan with a hub base station closest to the nearby local base station among the plurality of hub base stations as the transport source.
According to (7), the effort and time required to transport the battery from the hub base station as the transport source to the nearby local base station as the transport destination can be reduced.
(8) The transport plan generating device according to any one of (4) to (7), where
the transport plan generating device is configured to determine a number of times of transport for transporting the batteries for the number of transport batteries to the nearby local base station based on the number of transport batteries and an upper limit number of batteries that can be transported per one transport.
According to (8), taking into consideration the logistics network between the hub base station as the transport source and the nearby local base station as the transport destination, it is possible to appropriately transport batteries for the number of transport batteries from the hub base station as the transport source to the nearby local base station as the transport destination.
(9) The transport plan generating device according to (8), where
the transport plan generating device is configured to advance timing of starting transport to the nearby local base station as the number of times of transport increases.

According to (9), even when the number of times of transport increases, it is possible to avoid a delay in the timing at which the transport of batteries for the number of transport batteries to be transported to the nearby local base station is completed.
(10) A transport plan generating method executed by a computer for generating a transport plan of a battery that is to be attached to an electric apparatus from a hub base station where the battery is stored to a local base station where the battery is lent out to a user, the transport plan generating method being executed by the computer including:
acquiring use plan information including information representing the planned location of use for the electric apparatus, and specifying a nearby local base station, which is a local base station located near the planned location of use, based on the use plan information by referring to a storage unit that stores information representing a location of each local base station,
generating the transport plan with the specified nearby local base station as a transport destination, and
outputting transport plan information representing the generated transport plan to a terminal device of the hub base station.
According to (10), an employee at the hub base station can be urged to transport the battery to the nearby local base station located near the planned location of use for the electric apparatus. This makes it possible to deploy the batteries at the local base station where demand for batteries is expected, and thus it is possible to efficiently utilize a limited number of batteries and provide a battery sharing service that lends batteries to users.
(11) A transport plan generating program that causes a computer to execute a transport plan generating method for generating a transport plan of a battery that is to be attached to an electric apparatus from a hub base station where the battery is stored to a local base station where the battery is lent out to a user, where
the transport plan generating program causing the computer to execute processes of:
acquiring use plan information including information representing planned location of use for the electric apparatus, and specifying a nearby local base station, which is a local base station located near the planned location of use, based on the use plan information by referring to a storage unit that stores information representing a location of each local base station,
generating the transport plan with the specified nearby local base station as a transport destination, and
outputting transport plan information representing the generated transport plan to a terminal device of the hub base station.
According to (11), an employee at the hub base station can be urged to transport the battery to the nearby local base station located near the planned location of use for the electric apparatus. This makes it possible to deploy the batteries at the local base station where demand for batteries is expected, and thus it is possible to efficiently utilize a limited number of batteries and provide a battery sharing service that lends batteries to users.

### REFERENCE SIGNS LIST

10: transport plan generating device
20: terminal device
BAT: battery
Hb: hub base station
Lb1: local base station
M: work machine (electric apparatus)
W: worker (user)

1. A transport plan generating device for generating a transport plan of a battery that is to be attached to an electric apparatus from a hub base station where the battery is stored to a local base station where the battery is lent out to a user, the transport plan generating device being configured to:
acquire use plan information including information representing a planned location of use for the electric apparatus, and specify a nearby local base station, which is a local base station located near the planned location of use, based on the use plan information by referring to a storage unit that stores information representing a location of the local base station,
generate the transport plan with the specified nearby local base station as a transport destination, and
output transport plan information representing the generated transport plan to a terminal device of the hub base station.

2. The transport plan generating device according to claim 1, wherein
the nearby local base station is a local base station closest to the planned location of use.

3. The transport plan generating device according to claim 1, wherein
the use plan information further includes information representing a planned time period of use of the electric apparatus, and
the transport plan generating device is configured to generate the transport plan for transporting the battery to the nearby local base station by the planned time period of use based on the use plan information.

4. The transport plan generating device according to claim 1, wherein
the use plan information further includes information representing the electric apparatus, and
the transport plan generating device is configured to:
derive a required number of batteries required at the planned location of use based on the use plan information,
determine a number of transport batteries to be transported to the nearby local base station based on the required number of batteries, and
generate the transport plan for transporting batteries for the number of transport batteries to the nearby local base station.

5. The transport plan generating device according to claim 4, wherein
the transport plan generating device is configured to determine the number of transport batteries based on a difference between the required number of batteries and a number of surplus batteries held in the nearby local base station.

6. The transport plan generating device according to claim 4, wherein
the transport plan generating device is configured to generate the transport plan with the hub base station having surplus batteries for the number of transport batteries as a transport source.

7. The transport plan generating device according to claim 6, wherein
when there is a plurality of hub base stations each having surplus batteries for the number of transport batteries, the transport plan generating device generates the transport plan with a hub base station closest to the nearby local base station among the plurality of hub base stations as the transport source.

8. The transport plan generating device according to claim 4, wherein
the transport plan generating device is configured to determine a number of times of transport for transporting the batteries for the number of transport batteries to the nearby local base station based on the number of transport batteries and an upper limit number of batteries that can be transported per one transport.

9. The transport plan generating device according to claim 8, wherein
the transport plan generating device is configured to advance timing of starting transport to the nearby local base station as the number of times of transport increases.

10. A transport plan generating method executed by a computer for generating a transport plan of a battery that is to be attached to an electric apparatus from a hub base station where the battery is stored to a local base station where the battery is lent out to a user, the transport plan generating method being executed by the computer comprising:
acquiring use plan information including information representing a planned location of use for the electric apparatus, and specifying a nearby local base station, which is a local base station located near the planned location of use, based on the use plan information by referring to a storage unit that stores information representing a location of the local base station,
generating the transport plan with the specified nearby local base station as a transport destination, and
outputting transport plan information representing the generated transport plan to a terminal device of the hub base station.

11. A non-transitory computer-readable storage medium that stores a transport plan generating program that causes a computer to execute a transport plan generating method for generating a transport plan of a battery that is to be attached to an electric apparatus from a hub base station where the battery is stored to a local base station where the battery is lent out to a user, the transport plan generating program causing the computer to execute processes of:
acquiring use plan information including information representing a planned location of use for the electric apparatus, and specifying a nearby local base station, which is a local base station located near the planned location of use, based on the use plan information by referring to a storage unit that stores information representing a location of the local base station,
generating the transport plan with the specified nearby local base station as a transport destination, and
outputting transport plan information representing the generated transport plan to a terminal device of the hub base station.
